(19) United States
(12) Patent Application Publication
(10) Pub. No.: US 2024/0259450 A1
(43) Pub. Date: Aug. 1, 2024

(54) METHODS, APPARATUSES, AND MEDIUM FOR VIDEO STREAMING

(71) Applicants: Beijing Bytedance Network Technology Co., Ltd., Beijing (CN); Bytedance Inc., Los Angeles, CA (US)

(72) Inventors: Yongyi YU, Beijing (CN); Le YANG, Beijing (CN); Jianping CHEN, Beijing (CN); Ye-Kui WANG, Los Angeles, CA (US)

(21) Appl. No.: 18/622,581

(22) Filed: Mar. 29, 2024

Related U.S. Application Data
(63) Continuation of application No. PCT/CN2022/123103, filed on Sep. 30, 2022.

(30) Foreign Application Priority Data
Sep. 30, 2021 (WO) PCT/CN2021/122181

(51) Int. Cl. H04L 65/612

(52) U.S. Cl. CPC H04L 65/612

(57) ABSTRACT

Embodiments of the present disclosure provide a solution for video streaming. A method for retrieving media data comprises: determining, by a first device, identity information for a target segment of a media representation from a manifest file, the target segment being specified as comprising one of the following: a concatenation of an initialization segment for the media representation and a media segment containing media data if the initialization segment is absent from the manifest file, or the media segment containing the media data if the initialization segment is present in the manifest file; and retrieving the target segment based on the identity information.

### CROSS-REFERENCE TO RELATED APPLICATIONS

This application is a continuation of International Application No. PCT/CN2022/123103, filed on Sep. 30, 2022, which claims the benefit of International Application No. PCT/CN2021/122181, filed on Sep. 30, 2021. The entire contents of these applications are hereby incorporated by reference in their entireties.

### FIELD

Embodiments of the present disclosure relates generally to video processing techniques, and more particularly, to video streaming.

### BACKGROUND

Media streaming applications are typically based on the internet protocol (IP), transmission control protocol (TCP), and hypertext transfer protocol (HTTP) transport methods, and typically rely on a file format such as the ISO base media file format (ISOBMFF). One such streaming system is dynamic adaptive streaming over HTTP (DASH). In Dynamic adaptive streaming over HTTP (DASH), there may be multiple representations for video and/or audio data of multimedia content, different representations may correspond to different coding characteristics (e.g., different profiles or levels of a video coding standard, different bitrates, different spatial resolutions, etc.). With live streaming services becoming more and more popular, enhancement on DASH is required.

### SUMMARY

Embodiments of the present disclosure provide a solution for video streaming.

In a first aspect, a method for retrieving media data is proposed. The method comprises: determining, by a first device, identity information for a target segment of a media representation from a manifest file, the target segment being specified as comprising one of the following: a concatenation of an initialization segment for the media representation and a media segment containing media data if the initialization segment is absent from the manifest file, or the media segment containing the media data if the initialization segment is present in the manifest file; and retrieving the target segment based on the identity information.

In a second aspect, another method for providing media data is proposed. The method comprises: receiving, by a second device from a first device, a request for a target segment of a media representation, the request comprising identity information for the target segment, and the target segment comprising one of the following: a concatenation of an initialization segment for the media representation and a media segment containing media data if the initialization segment is absent from the manifest file, or the media segment containing the media data if the initialization segment is present in the manifest file; and transmitting, to the first device, the target segment referenced by the identity information.

In a third aspect, an apparatus for retrieving media data is proposed. The apparatus for retrieving media data comprises a processor and a non-transitory memory with instructions thereon. The instructions, upon execution by the processor, cause the processor to perform a method in accordance with the first aspect of the present disclosure.

In a fourth aspect, an apparatus for providing media data is proposed. The apparatus for retrieving media data comprises a processor and a non-transitory memory with instructions thereon. The instructions, upon execution by the processor, cause the processor to perform a method in accordance with the second aspect of the present disclosure.

In a fifth aspect, a non-transitory computer-readable storage medium is proposed. The non-transitory computer-readable storage medium stores instructions that cause a processor to perform a method in accordance with the first aspect of the present disclosure.

In a sixth aspect, a non-transitory computer-readable storage medium is proposed. The non-transitory computer-readable storage medium stores instructions that cause a processor to perform a method in accordance with the second aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of an example of TIMS in MIME multipart message format in accordance with some embodiments of the present disclosure;

FIG. 5 illustrates a flowchart of a process for a CDN generating a TIMS without the segments being cached in accordance with some embodiments of the present disclosure;

FIG. 6 illustrates a flowchart of a method implemented at a first device according to embodiments of the present disclosure;

FIG. 7 illustrates a schematic diagram of an example system that implements techniques for streaming media data over a network in accordance with some embodiments of the present disclosure;

FIG. 8 illustrates a signaling flow for streaming media data according to embodiments of the present disclosure;

FIG. 9 illustrates a flowchart of a method implemented at a second device according to embodiments of the present disclosure; and

FIG. 10 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

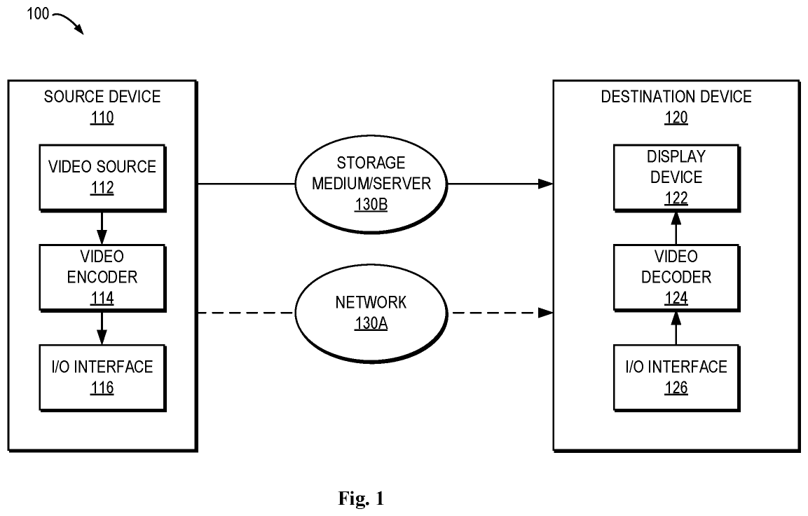

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

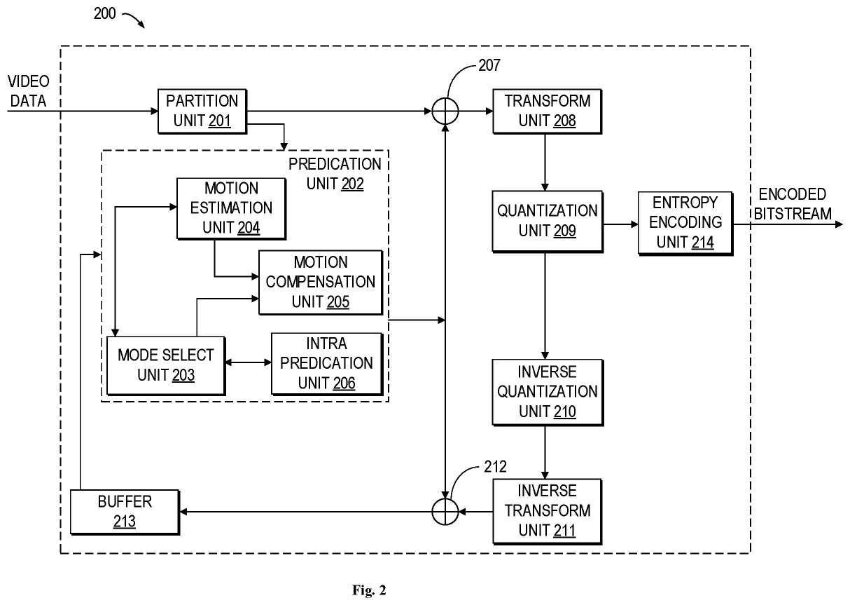

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

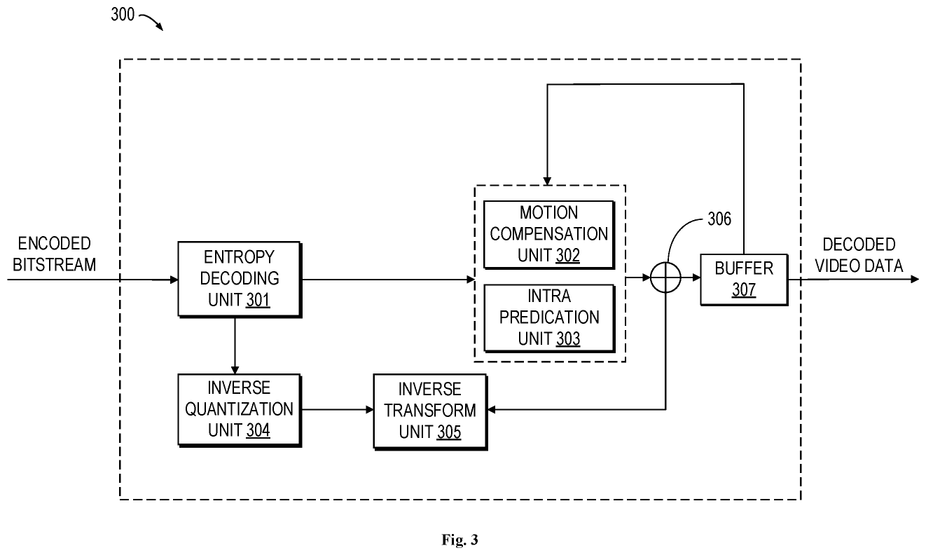

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

Embodiments of the present disclosure are related to video streaming. Specifically, it is related to the definition of a new type of media segment and related signalling to enable minimizing the initialization delay in live media streaming. The embodiments may be applied individually or in various combinations, for media streaming systems, e.g., based on the Dynamic Adaptive Streaming over HTTP (DASH) standard or its extensions.

### 2. BACKGROUND

### 2.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVCstandards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC [3] is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 2.2. File Format Standards

Media streaming applications are typically based on the IP, TCP, and HTTP transport methods, and typically rely on a file format such as the ISO base media file format (ISOBMFF). One such streaming system is dynamic adaptive streaming over HTTP (DASH). For using a video format with ISOBMFF and DASH, a file format specification specific to the video format, such as the AVC file format and the HEVC file format, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session.

Similarly, for using an image format with ISOBMFF, a file format specification specific to the image format, such as the AVC image file format and the HEVC image file format, would be needed.

The VVC video file format, the file format for storage of VVC video content based on ISOBMFF, is currently being developed by MPEG. The latest draft specification of the VVC video file format is included.

The VVC image file format, the file format for storage of image content coded using VVC, based on ISOBMFF, is currently being developed by MPEG. The latest draft specification of the VVC image file format is included.

### 2.3. DASH

In Dynamic adaptive streaming over HTTP (DASH), there may be multiple representations for video and/or audio data of multimedia content, different representations may correspond to different coding characteristics (e.g., different profiles or levels of a video coding standard, different bitrates, different spatial resolutions, etc.). The manifest of such representations may be defined in a Media Presentation Description (MPD) data structure. A media presentation may correspond to a structured collection of data that is accessible to DASH streaming client device. The DASH streaming client device may request and download media data information to present a streaming service to a user of the client device. A media presentation may be described in the MPD data structure, which may include updates of the MPD.

A media presentation may contain a sequence of one or more periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

A typical DASH streaming procedure is shown by the following steps:
1) The client gets the MPD.
2) The client estimates the downlink bandwidth, and selects a video representation and an audio representation according to the estimated downlink bandwidth and the codec, decoding capability, display size, audio language setting, etc.
3) Unless the end of the media presentation is reached, the client requests media segments of the selected representations and presents the streaming content to the user.
4) The client keeps estimating the downlink bandwidth. When the bandwidth changes to a direction (e.g., becomes lower) significantly, the client selects a different video representation to match the newly estimated bandwidth, and go to step 3.

### 2.4. Video RTP Payload Formats and SDP

For any video codec, e.g., VVC, be used in video applications using the real-time transport protocol (RTP), an RTP payload format needs to be specified, along with signalling of media type parameters using the session description protocol (SDP). The RTP payload format for a video codec mainly specifies how to encapsulate the coded video bitstreams in RTP packets and RTP streams.

The RTP payload formats for AVC, SVC, and HEVC are specified in IETF RFC 6184, RFC 6190, and RFC 7798, respectively. For VVC, currently the RTP payload is being developed by the IETF.

### 3. PROBLEMS

In live streaming based on DASH, particularly when the live “broadcasters” are users using all kinds of mobile devices, it is often difficult to ensure constant Segment durations. The video camera of the device may capture video at different varying frame rates. The video encoder may skip a frame from time to time due to computing resource issues. Therefore, it is not always possible to use the simple and nice approach based on the @duration attribute that specifies the constant approximate Segment duration. Consequently, many live streaming services are forced to use the SegmentTimeline element.

However, using SegmentTimeline often requires a client to request the latest MPD whenever tuning into a live streaming session, even if the client prefetched an earlier version of the MPD. Basically, the client firstly requests the latest MPD to obtain the URL information of the latest Media Segment, then it requests the Initialization Segment and the latest Media Segment and continues from there. This need of multiple roundtrips and multiple requests causes additional initialization delay (the delay between the time moments when a user presses the “Start”/“Join” button and when the first picture is displayed) compared to the case when it is possible to use the @duration attribute and the $number$-identifier-based URL template for Segments.

### 4. DETAILS

To solve the above-described problem, methods as summarized below are disclosed. Embodiments of the present disclosure should be considered as examples to explain the general concepts and should not be interpreted in a narrow way. Furthermore, these embodiments can be applied individually or combined in any manner.
1) A new type of media segment, named Tuning-In Media Segment (TIMS) is defined.
   a. A TIMS is either the concatenation of an Initialization Segment (IS) and a single Simple Media Segment with the first access unit of the first movie fragment in each track of the Simple Media Segment corresponding to the Iₛₐᵤ of a SAP of type 1, 2, or 3 (e.g., in case the IS is not included in the MPD), or just the single Simple Media Segment (e.g., in case the IS is included in the MPD).
      i. Alternatively, a TIMS is the concatenation of an Initialization Segment and a single Media Segment of another type with the first access unit of the first movie fragment in each track of the Media Segment corresponding to the Iₛₐᵤ of a SAP of type 1, 2, or 3.
         1. In examples, the another type of Media Segment may be a Delivery Unit Media Segment, an Indexed Media Segment, or a Random Access Media Segment.
      ii. Alternatively or additionally, a TIMS could be served using an MIME multipart message, by putting the Initialization Segment and the Media Segment as different parts in it, instead of concatenating them together.
         1. In one example, when using a CDN, this way of serving a TIMS is used by an edge server of the CDN to send a TIMS to a client, e.g., the CDN's edge server may generate the TIMS MIME multipart message with separate Initialization Segment and Media Segment, instead asking the origin server for a TIMS, which may generate large traffic between the origin server and the CDN.
         a. In one example, additionally, the origin server may notify the CDN which Media Segment should be included in the TIMS, e.g., by including the Media Segment's URL within the HTTP response header.
         2. In one example, this way of serving a TIMS is used by an origin sever to send a TIMS to an edge server, a cache, or directly to a client.
   b. A TIMS contains the latest media data for clients to start with when tuning into the ongoing live streaming service.
2) The addition of an optional element to the SegmentBase element, for specifying the URL for the Tuning-In Media Segment.
3) The addition of an optional attribute to the SegmentTemplate element, for specifying the URL for the Tuning-In Media Segment.
4) The definition of Live Streaming Tuning-In Event, for signalling of the segment number and the earliest presentation time of the Tuning-In Media Segment using the ‘emsg’ box.

With In this contribution, we propose a set of changes, as summarized in the abstract, to minimize the initialization delay in live streaming scenarios using the SegmentTimeline element instead of the @duration attribute.

With these additions, for live streaming using the SegmentTimeline element, when the MPD is prefetched, a client would be able to tune in and start consuming the first Media Segment by sending only one HTTP request, and there is no need to request an MPD update each time before requesting a next Media Segment. By using such a design, as observed from experiment results, the initialization delay could be reduced from 1110 ms to 848 ms, which is a 23.6% reduction.

### 5. EMBODIMENTS

Below are some example embodiments for some of the aspects according to embodiments of the present disclosure summarized above in Section 4.

### 5.1. Embodiment 1

This embodiment is for items 1, 1.a, 1.b, and 2 to 4. This embodiment can be applied to DASH. Relative to the 4th edition text of the DASH standard specification in MPEG input document m52458, most relevant parts that have been added or modified are highlighted in underline, and some of the deleted parts are highlighted in strikethrough. There may be some other changes that are editorial in nature and thus not highlighted.

### 5.3.9.2 Segment Base Information

### 5.3.9.2.1 Overview

The SegmentBase element is sufficient to describe the Segment Information if and only if a single Media Segment is provided per Representation and the Media Segment URL is included in the BaseURL element.

In case multiple Media Segments are present, either a SegmentList or a SegmentTemplate shall be used to describe the Segment Information. SegmentList or a SegmentTemplate share the multiple Segment base information as provided in subclause 5.3.9.2.2, Table 16.

If the Representation contains more than one Media Segment, then either the attribute @duration or the element SegmentTimeline shall be present. The attribute @duration and the element SegmentTimeline shall not be present at the same time.

Segments described by the Segment base information are referenced by an HTTP-URL conforming to the type URLType as defined in Table 17.

The semantics of the attributes and elements for the SegmentBase element and the Segment base information are provided in subclause 5.3.9.2.2, Table 15 and the multiple Segment base information in Table 16 in subclause 5.3.9.2.2. The XML syntax of the Segment Base Information is provided in subclause 5.3.9.2.3.

### 5.3.9.2.2 Semantics

TABLE 15
Semantics of SegmentBase element and Segment Base Information type

| Element or Attribute Name | Use | Description |
|---|---|---|
| SegmentBase | | specifies Segment base element. |
| Segment Base Information | | This element also specifies the type for the |
| | | Segment base information that is the base type |
| | | for other elements. |
| @timescale | O | specifies the timescale in units per seconds to |
| | | be used for the derivation of different real-time |
| | | duration values in the Segment Information. |
| | | If not present on any level, it shall be set to 1. |
| | | NOTE This can be any frequency but |
| | | typically is the media clock frequency of one |
| | | of the media streams (or a positive integer |
| | | multiple thereof). |
| @presentation TimeOffset | O | specifies the presentation time offset of the |
| | | Representation relative to the start of the |
| | | Period, i.e. the presentation time value of the |
| | | media stream that shall be presented at the start |
| | | of this Period. |
| | | The value of the presentation time offset in |
| | | seconds is the division of the value of this |
| | | attribute and the value of the @timescale |
| | | attribute. |
| | | If not present on any level, the value of the |
| | | presentation time offset is 0. |
| @eptDelta | O | specifies the difference between the earliest |
| | | presentation time in the Representation and the |
| | | value of the @presentation TimeOffset. |
| | | The value of the earliest presentation time of |
| | | the first Media Segment in this Representation |
| | | in seconds is computed the sum of the value of |
| | | this attribute and the value of the |
| | | @presentationTimeOffset in units of the |
| | | @timescale attribute. |
| | | If not present on any level, but the |
| | | SegmentTimeline element is present, then the |
| | | value is the value of the @t attribute of the first |
| | | S element in the Segment minus the value of |
| | | the @presentation TimeOffset. Otherwise it |
| | | assumed to be 0. |
| @presentationDuration | 0 | specifies the presentation duration of the |
| | | Representation in the Period. |
| | | The value of the presentation duration in |
| | | seconds is the division of the value of this |
| | | attribute and the value of the @timescale |
| | | attribute. Specifically, the sum of the value of |
| | | the @presentationTimeOffset, if present, or |
| | | 0 otherwise and the value of this attribute is the |
| | | last presentation time to be presented for this |
| | | Representation. |
| | | If not present on any level, the value of this |
| | | attribute is unknown and the Representation |
| | | should be presented until the end of the Period, |
| | | i.e. until the presentation is terminated or until |
| | | the next Period starts. |
| @timeShiftBufferDepth | O | specifies the duration of the time shifting |
| | | buffer for this Representation that is |
| | | guaranteed to be available for a Media |
| | | Presentation with type 'dynamic'. When not |
| | | present, the value is of the |
| | | @timeShiftBufferDepth on MPD level |
| | | applies. If present, this value shall be not |
| | | smaller than the value on MPD level. This |
| | | value of the attribute is undefined if the @type |
| | | attribute is equal to ‘static’. |
| | | NOTE When operating in a time-shift buffer |
| | | on a Representation with value larger than the |
| | | time-shift buffer signalled on MPD level, not |
| | | all Representations are necessarily available |
| | | for switching. |
| @indexRange | O | specifies the byte range that contains the |
| | | Segment Index in all Media Segments of the |
| | | Representation. |
| | | The byte range shall be expressed and |
| | | formatted as a byte-range-spec as defined in |
| | | IETF RFC 7233:2014, subclause 2.1. It is |
| | | restricted to a single expression identifying a |
| | | contiguous range of bytes. |
| | | If not present, the value is unknown. |
| @indexRangeExact | OD | when set to ‘true’ specifies that for all |
| | default | Segments in the Representation, the data |
| | “false” | outside the prefix defined by @indexRange |
| | | contains the data needed to access all access |
| | | units of all media streams syntactically and |
| | | semantically. |
| | | This attribute shall not be present if |
| | | @indexRange is absent. |
| @availabilityTimeOffset | O | specifies an offset to define the adjusted |
| | | segment availability time. The value is |
| | | specified in seconds, possibly with arbitrary |
| | | precision. |
| | | The offset provides the time how much earlier |
| | | these segments are available compared to their |
| | | computed availability start time for all |
| | | Segments of all associated Representation. |
| | | The segment availability start time defined by |
| | | this value is referred to as adjusted segment |
| | | availability start time. For details on computing |
| | | the adjusted segment availability start time, |
| | | refer to subclause 5.3.9.5. |
| | | If not present, no adjusted segment availability |
| | | start time is defined. |
| | | NOTE The value of “INF” implies |
| | | availability of all segments starts at |
| | | MPD@availabilityStartTime. |
| @availabilityTimeComplete | O | specifies if all Segments of all associated |
| | | Representation are complete at the adjusted |
| | | availability start time. The attribute shall be |
| | | ignored if @availabilityTimeOffset is not |
| | | present on any level. |
| | | If not present on any level, the value is inferred |
| | | to true. |
| | | NOTE If the value is set to false, then it can |
| | | be inferred by the client that the segment is |
| | | available at its announced location prior being |
| | | complete. |
| Initialization | 0 . . . 1 | specifies the URL including a possible byte |
| | | range for the Initialization Segment. |
| | | For the type definition, refer to Table 17. |
| TuningIn | 0 . . . 1 | specifies the URL including a possible byte |
| | | range for the Tuning-In Media Segment. |
| | | Alternatively, this specifies the URL for the |
| | | Tuning-In Media Segment. |
| | | For the type definition, refer to Table 17. |
| RepresentationIndex | 0 . . . 1 | specifies the URL including a possible byte |
| | | range for the Representation Index Segment. |
| | | For the type definition, refer to Table 17. |
| FailoverContent | 0 . . . 1 | specifies times where the content has been |
| | | replaced by failover content, for example |
| | | because of an encoder error. |
| | | For details refer to 5.3.9.7. |

Key
For attributes:
M = mandatory,
O = optional,
OD = optional with default value,
CM = conditionally mandatory
For elements: < minOccurs> . . . < maxOccurs> (N = unbounded)
Elements are bold;
attributes are non-bold and preceded with an @.

TABLE 16
Semantics of Multiple SegmentBaseInformation type

| Element or Attribute Name | Use | Description |
|---|---|---|
| Multiple SegmentBaseInformation | | specifies multiple Segment base information. |
| @duration | O | If present, specifies the constant approximate |
| | | Segment duration. |
| | | All Segments within this Representation |
| | | element have the same duration unless it is the |
| | | last Segment within the Period, which can be |
| | | significantly shorter. |
| | | The value of the duration in seconds is the |
| | | division of the value of this attribute and the |
| | | value of the @timescale attribute associated |
| | | to the containing Representation. |
| | | For more details, refer to subclause 5.3.9.5.3. |
| @startNumber | O | specifies the number of the first Media |
| | | Segment in this Representation in the Period. |
| | | For details, refer to subclause 5.3.9.5.3. |
| @endNumber | O | specifies the number of the last Media Segment |
| | | in this Representation in the Period. |
| | | If not present, the number is inferred from the |
| | | duration of the Period. |
| | | For details refer to 5.3.9.5.3. |
| Segment Base Information | | specifies Segment base information. |
| SegmentTimeline | 0 . . . 1 | specifies the timeline of arbitrary Segment |
| | | durations |
| | | For more details, see subclause 5.3.9.6. |
| BitstreamSwitching | 0 . . . 1 | specifies the URL including a possible byte |
| | | range for the Bitstream Switching Segment. |
| | | For the type definition, refer to Table 17. |

Key
For attributes:
M = mandatory,
O = optional,
OD = optional with default value,
CM = conditionally mandatory
For elements: < minOccurs> . . . < maxOccurs> (N = unbounded)
Elements are bold;
attributes are non-bold and preceded with an @.

TABLE 17
Semantics of elements of type URLType

| Element or Attribute Name | Use | Description |
|---|---|---|
| Element of type URLType | | defines an HTTP-URL |
| @sourceURL | O | specifies the source URL part and shall be formatted |
| | | either as an <absolute-URI> according to |
| | | IETF RFC 3986:2005, subclause 4.3, with a fixed |
| | | scheme of “http” or “https” or as a <relative-ref> |
| | | according to IETF RFC 3986:2005, subclause 4.2. |
| | | If not present, then any BaseURL element is mapped |
| | | to the @sourceURL attribute and the range attribute |
| | | shall be present. |
| @range | O | specifies the byte range restricting the above HTTP- |
| | | URL. |
| | | The byte range shall be expressed and formatted as a |
| | | byte-range-spec as defined in IETF RFC 7233:2014, |
| | | subclause 2.1. It is restricted to a single expression |
| | | identifying a contiguous range of bytes. |
| | | If not present, the element refers to the entire resource |
| | | referenced in the @sourceURL attribute. |

5.3.9.2.3 XML Syntax

```
<!-- Segment information base -->
<xs:complexType name=“SegmentBaseType”>
  <xs:sequence>
    <xs:element name=“Initialization” type=“URLType” minOccurs=“0”/>
    <xs:element name=“TuningIn” type=“URLType” minOccurs=“0”/>
    <xs:element name=“RepresentationIndex” type=“URLType” minOccurs=“0”/>
    <xs:element name=“FailoverContent” type=“FailoverContentType” minOccurs=“0”/>
    <xs:any namespace=“##other” processContents=“lax” minOccurs=“0” maxOccurs=“unbounded”/>
  </xs:sequence>
  <xs:attribute name=“timescale” type=“xs:unsignedInt”/>
  <xs:attribute name=“eptDelta” type=“xs:integer”/>
  <xs:attribute name=“presentationTimeOffset” type=“xs:unsignedLong”/>
  <xs:attribute name=“presentationDuration” type=“xs:unsignedLong”/>
  <xs:attribute name=“timeShiftBufferDepth” type=“xs:duration”/>
  <xs:attribute name=“indexRange” type=“SingleRFC7233RangeType”/>
  <xs:attribute name=“indexRangeExact” type=“xs:boolean” default=“false”/>
  <xs:attribute name=“availabilityTimeOffset” type=“xs:double”/>
  <xs:attribute name=“availabilityTimeComplete” type=“xs:boolean”/>
  <xs:anyAttribute namespace=“##other” processContents=“lax”/>
</xs:complexType>
<!-- Multiple Segment information base -->
<xs:complexType name=“MultipleSegmentBaseType”>
  <xs:complexContent>
    <xs:extension base=“SegmentBaseType”>
      <xs:sequence>
        <xs:element name=“SegmentTimeline” type=“SegmentTimelineType” minOccurs=“0”/>
        <xs:element name=“BitstreamSwitching” type=“URLType” minOccurs=“0”/>
      </xs:sequence>
      <xs:attribute name=“duration” type=“xs:unsignedInt”/>
      <xs:attribute name=“startNumber” type=“xs:unsignedInt”/>
      <xs:attribute name=“endNumber” type=“xs:unsignedInt”/>
    </xs:extension>
  </xs:complexContent>
</xs:complexType>
<!-- Segment Info item URL/range -->
<xs:complexType name=“URLType”>
  <xs:sequence>
    <xs:any namespace=“##other” processContents=“lax” minOccurs=“0” maxOccurs=“unbounded”/>
  </xs:sequence>
  <xs:attribute name=“sourceURL” type=“xs:anyURI”/>
  <xs:attribute name=“range” type=“SingleRFC7233RangeType”/>
  <xs:anyAttribute namespace=“##other” processContents=“lax”/>
</xs:complexType>
<xs:simpleType name=“SingleRFC7233RangeType”>
  <xs:restriction base=“xs:string”>
    <xs:pattern value=“([0-9]*)(\-([0-9]*))?”/>
  </xs:restriction>
</xs:simpleType>
```

### 5.3.9.4 Segment Template

### 5.3.9.4.1 Overview

The Segment template is defined by the SegmentTemplate element. In this case, specific identifiers that are substituted by dynamic values assigned to Segments, to create a list of Segments. The substitution rules are provided in subclause 5.3.9.4.4.

The semantics of the attributes and elements for the Segment list are provided in subclause 5.3.9.4.2, Table 19. The XML syntax of the Segment Information is provided in subclause 5.3.9.4.3.

### 5.3.9.4.2 Semantics

TABLE 19
Semantics of SegmentTemplate element

| Element or Attribute Name | Use | Description |
|---|---|---|
| SegmentTemplate | | specifies Segment template information. |
| Multiple SegmentBaseInformation | | Provides the Multiple Segment base information |
| | | as defined in subclause 5.3.9.2. |
| @media | O | specifies the template to create the Media |
| | | Segment List. |
| | | For more details, refer to subclause 5.3.9.4.4. |
| @index | O | specifies the template to create the Index Segment |
| | | List. If neither the $Number$ nor the $Time$ |
| | | identifier is included, this provides the URL to a |
| | | Representation Index. |
| | | For more details, refer to subclause 5.3.9.4.4. |
| @initialization | O | specifies the template to create the Initialization |
| | | Segment. Neither $Number$ nor the $Time$ |
| | | identifier shall be included. |
| | | For more details, refer to subclause 5.3.9.4.4. |
| @tuningIn | O | specifies the template to create the Tunning-In |
| | | Media Segment. Neither $Number$ nor the |
| | | $Time$ identifier shall be included. |
| | | For more details, refer to subclause 5.3.9.4.4. |
| @bitstreamSwitching | O | specifies the template to create the Bitstream |
| | | Switching Segment. Neither $Number$ nor the |
| | | $Time$ identifier shall be included. |
| | | For more details, refer to subclause 5.3.9.4.4. |

Key
For attributes:
M = mandatory,
O = optional,
OD = optional with default value,
CM = conditionally mandatory
For elements: < minOccurs> . . . < maxOccurs> (N = unbounded)
Elements are bold;
attributes are non-bold and preceded with an @.

5.3.9.4.3 XML syntax

```
<!-- Segment Template -->
<xs:complexType name=“SegmentTemplateType”>
  <xs:complexContent>
    <xs:extension base=“MultipleSegmentBaseType”>
      <xs:attribute name=“media” type=“xs:string”/>
      <xs:attribute name=“index” type=“xs:string”/>
      <xs:attribute name=“initialization” type=“xs:string”/>
      <xs:attribute name=“tuningIn” type=“xs:string”/>
      <xs:attribute name=“bitstreamSwitching” type=“xs:string”/>
    </xs:extension>
  </xs:complexContent>
</xs:complexType>
```

### 5.3.9.4.4 Template-Based Segment URL Construction

The SegmentTemplate@media attribute, the SegmentTemplate@index attribute, the SegmentTemplate@initialization attribute, the SegmentTemplate@tuningIn attribute and the SegmentTemplate@bitstreamSwitching attribute each contain a string that may contain one or more of the identifiers as listed in Table 20.

In each URL, the identifiers from Table 20 shall be replaced by the substitution parameter defined in Table 16. Identifier matching is case-sensitive. If the URL contains unescaped $ symbols which do not enclose a valid identifier, then the result of URL formation is undefined. In this case, it is expected that the DASH Client ignores the entire containing Representation element and the processing of the MPD continues as if this Representation element was not present. The format of the identifier is also specified in Table 20.

Each identifier may be suffixed, within the enclosing ‘$’ characters, with an additional format tag aligned with the printf format tag as defined in IEEE 1003.1-2008 following this prototype:
%0[width]d

The width parameter is an unsigned integer that provides the minimum number of characters to be printed. If the value to be printed is shorter than this number, the result shall be padded with zeros. The value is not truncated even if the result is larger.

The Media Presentation shall be authored such that the application of the substitution process results in valid Segment URLs.

Strings outside identifiers shall only contain characters that are permitted within URLs according to IETF RFC 3986.

TABLE 20
Identifiers for URL templates

| $<Identifier>$ | Substitution parameter | Format |
|---|---|---|
| $$ | Is an escape sequence, i.e. “$$” is replaced with a | not applicable |
| | single “$” | |
| $RepresentationID$ | This identifier is substituted with the value of the | The format tag shall not be |
| | attribute Representation@id of the containing | present. |
| | Representation. | |
| $Number$ | This identifier is substituted with the number of the | The format tag may be present. |
| | corresponding Segment, if $SubNumber$ is not | If no format tag is present, a |
| | present in the same string. | default format tag with width = 1 |
| | If $SubNumber$ is present, this identifier is | shall be used. |
| | substituted with the number of the corresponding | |
| | Segment sequence. For details, refer to subclauses | |
| | 5.3.9.6.4 and 5.3.9.6.5. | |
| $Bandwidth$ | This identifier is substituted with the value of | The format tag may be present. |
| | Representation@bandwidth attribute value. | If no format tag is present, a |
| | | default format tag with width = 1 |
| | | shall be used. |
| $Time$ | This identifier is substituted with the value of the | The format tag may be present. |
| | MPD start time of the Segment being accessed. For | If no format tag is present, a |
| | the Segment Timeline, this means that this identifier | default format tag with width = 1 |
| | is substituted with the value of the | shall be used. |
| | SegmentTimeline@t attribute for the Segment | |
| | being accessed. Either $Number$ or $Time$ may | |
| | be used but not both at the same time. | |
| $SubNumber$ | This identifier is substituted with the number of the | The format tag may be present. |
| | corresponding Segment in a Seqment Sequence. This | If no format tag is present, a |
| | identifier shall only be present if either $Number$ or | default format tag with width = 1 |
| | $Time$ are present as well. For details, refer to | shall be used. |
| | subclauses 5.3.9.6.4 and 5.3.9.6.5. | |

### 5.3.9.4 Segment Information

. . .

### 5.3.9.5.6 Tuning-In Media Segment Information

Each Representation has assigned at most one Tuning-In Media Segment. Alternatively, each Representation has assigned at zero or more Tuning-In Media Segments.

The presence of a Tuning-In Media Segment is indicated by the presence of SegmentBase.TuningIn, SegmentList.TuningIn, the SegmentTemplate.TuningIn element or the SegmentTemplate@tuningIn attribute that may contain URL and byte range information or URL construction rules for the Tuning-In Media Segment.

When a Tuning-In Media Segment is present for a Representation, it is recommended that the SegmentTemplate@media attribute with the $Number$ identifier is used, and the SegmentTimeline element is used.

### 5.10.4 DASH-Specific Events

. . .

### 5.10.4.7 Live Streaming Tuning-In Event

A live streaming tuning-in event indicates that the current Segment is a Tuning-In Media Segment. This event is identified by the URN “urn:mpeg:dash:event:tuin:2021”.

For events using this schema, the ‘emsg’.message data[ ] field contains the DASHTuningIn structure defined below:
aligned(8) struct DASHTuningIn
{
   unsigned int(32) segment_number;
   unsigned int(64) earliest presentation time;
}
   segment number provides the Segment number of the Media Segment part of the Tuning-In Media Segment.
   earliest_presentation time provides the earlier presentation time of any access unit in the Tuning-In Media Segment. The timescale is provided in the timescale field of the current ‘emsg’ box.

Alternatively, the field earliest_presentation_time is not included in the DASHTuningIn structure.

### 6.3.4 Media Segment Types

### 6.3.4.1 General

Media Segments can be of different types: Delivery Unit Media Segments, simple Media Segments, Random Access Media Segments, Switching Media Segments, Indexed Media Segments, Sub-Indexed Media Segments, and Tuning-In Media Segments.

All Media Segments shall conform to the general definitions in subclause 6.3.4.2. Additional type-specific constraints are provided further below in subclause 6.3.4.

Further rules on Media Segments in combination with certain MPD attributes are provided in subclause 7.3.

Media Segments may conform to multiple types. Conformance can be expressed by adding the brand(s) to the ‘styp’ box as a compatible brand and, if applicable, as the major brand.

Unless explicitly mentioned differently, the boxes referred in subclause 6.3.4 are specified in ISO/IEC 14496-12.

### 6.3.4.2 Delivery Unit Media Segment

A Media Segment conforming to the Delivery Unit Media Segment Format is defined as follows:
Each Media Segment shall contain one or more whole self-contained movie fragments. A whole, self-contained movie fragment is a movie fragment (′moof) box and a media data (‘mdat’) box that contains all the media samples that do not use external data references referenced by the track runs in the movie fragment box.
Each ‘moof’ box shall contain at least one track fragment.
The ‘moof’ boxes shall not use external data references, the flag ‘default-base-is-moof’ shall be set, and data-offset shall be used, i.e. ‘base-data-offset-present’ shall not be used. This combination of settings is referred to as movie-fragment relative addressing for media data.
Absolute byte-offsets shall not be used for this media data. In a movie fragment, the duration by which each track extends should be as close to equal as practical. In particular, as movie fragments are accumulated, the track durations should remain close to each other and there should be no ‘drift’.
Each Media Segment may carry ‘dums’ in the Segment Type box (‘styp’) as a compatible brand. The conformance requirements of this brand are defined in this subclause.

### 6.3.4.3 Simple Media Segment

A Media Segment conforming to the Simple Media Segment Format for DASH is defined as follows:
It shall conform to the Delivery Unit Media Segment format as specified in subclause 6.3.4.2.
Each ‘traf’ box shall contain a ‘tfdt’ box.
   NOTE The track fragment adjustment box ‘tfad’ as defined in 3GPP TS26.244 can also be present. DASH Clients are discouraged to apply both the alignment established by the ‘tfdt’ and the time-shifting implied by the ‘tfad’, which would result in a double correction.
Each Simple Media Segment may contain one or more ‘sidx’ boxes. If present, the first ‘sidx’ box shall be placed before any ‘moof’ box and the first Segment Index box shall document the entire Segment.
For the purpose of determining overlapping and non-overlapping segments, redundant samples as defined in ISO/IEC 14496-12 shall be ignored. In other words, the earliest presentation time of any access unit in the stream shall be computed without taking redundant samples into account.
Each Media Segment may contain a ‘styp’ box and if present shall carry ‘msdh’ as a compatible brand. The conformance requirement of this brand is defined in this subclause.

### 6.3.4.4 Indexed Media Segment

A Media Segment conforming to the Indexed Media Segment Format is defined as follows:
Each Media Segment shall comply with the Delivery Unit Media Segment as defined in subclause 6.3.4.2 and in addition in each self-contained movie fragment, the movie fragment (‘moof’) box is immediately followed by its corresponding media data (‘mdat’).
Each Media Segment shall contain one or more ‘sidx’ boxes. The first ‘sidx’ box shall be placed before any ‘moof’ box and shall document Subsegments that span the composition time of the entire Segment.
Each Media Segment shall carry ‘msix’ as a compatible brand. The conformance requirements of this brand are defined in this subclause.

### 6.3.4.5 Sub-Indexed Media Segment

A Media Segment conforming to the Sub-Indexed Media Segment Format is defined as follows:
It shall conform to the indexed Media Segment format as specified in subclause 6.3.4.3.
The Subsegment Index box (‘ssix’) shall be present and shall follow immediately the ‘sidx’ box that documents the same Subsegment. This immediately preceding ‘sidx’ shall only index Media Subsegments.
It shall carry ‘sims’ in the Segment Type box (‘styp’) as a compatible brand. The conformance requirements of this brand are defined in this subclause.

### 6.3.4.6 Random Access Media Segment

A Media Segment conforming to the Random Access Media Segment Format is defined as follows:

It shall conform to the Simple Media Segment format as specified in subclause 6.3.4.3.

The first access unit in each movie fragment in a Random Access Media Segment shall correspond to the Iₛₐᵤ of a SAP of type 1, 2, or 3.

The media segment shall carry sufficient information to access the media in the stream, e.g. all necessary encryption in combination with the Initialization Segment, if available.

### 6.3.4.7 Tuning-In Media Segment

The Tuning-In Media Segment conforms to the concatenation of an Initialization Segment (as specified in subclause 6.3.3) and a single Simple Media Segment (as specified in subclause 6.3.4.3) with the first access unit of the first movie fragment in each track of the Simple Media Segment corresponding to the Iₛₐᵤ of a SAP of type 1, 2, or 3.

When MPD@type is “dynamic”, a Tuning-In Media Segment contains the latest media data for clients to start with when tuning into the ongoing live streaming service. Depending on the length of the current Media Segment that is being generated by the server, the Media Segment in the Tuning-In Media Segment can be either the current Media Segment (e.g., when the current Media Segment is made available with at least a couple of seconds of media data encapsulated) or the previous Media Segment (e.g., when only a small part of the current Media Segment has been generated).

### 8.11.2 Media Presentation Description Constraints

. . .

### 8.11.2.5 Constraints on SegmentTemplate Elements

The @initialization attribute and the @tuningIn attribute may include data URLs as defined in IETF RFC 2397.

### 5.2. Embodiment 2

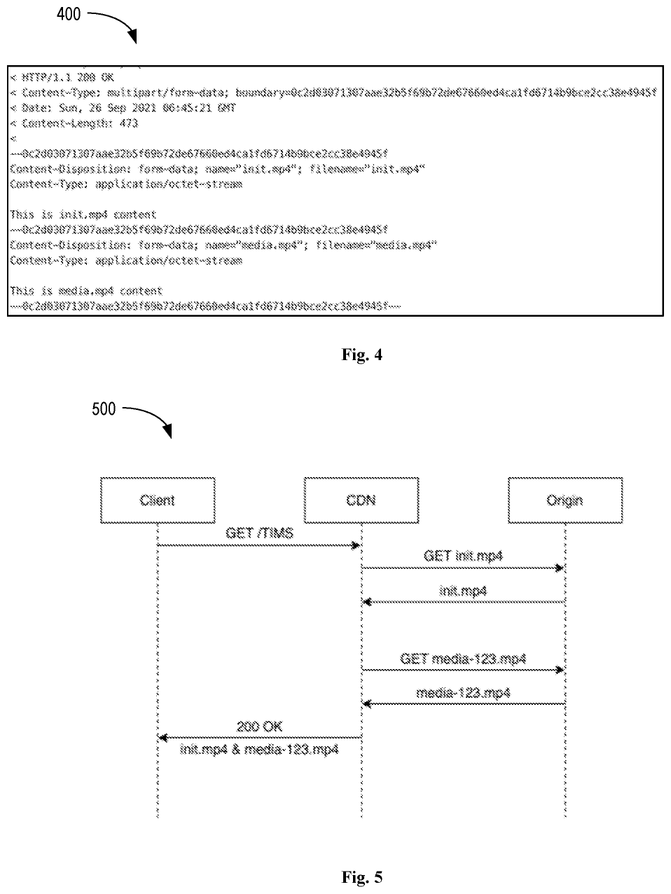

This embodiment is for item 1.a. ii. This embodiment can be applied to generate a TIMS using an MIME multipart message. When serving a TIMS using an MIME multipart message, a server should put the Initialization Segment first and then the Media Segment. FIG. 4 shows what a TIMS in a MIME multipart message format 400 looks like. When using a CDN, the TIMS may be generated by the CDN's edge server. The CDN should first load the Initialization Segment from its cache, put it into the TIMS message, then load the Media Segment form its cache and also put it into the TIMS message. If either or both of the Initialization Segment and the Media Segment are not in the CDN's cache, the CDN should ask the origin server for them using normal HTTP requests. FIG. 5 shows a process 500 of how the CDN generates a TIMS without the segments being cached. However, the CDN may not be able to decide which Media Segment should be included into the TIMS, therefore the origin server needs to notify the CDN which Media Segment should be used in the TIMS in some ways, including but not limited to carrying the Media Segment's URL within the HTTP response header. If the CDN doesn't have information about the Media Segment to be included in TIMS, then it should ask the origin server for the whole TIMS using a normal HTTP request.

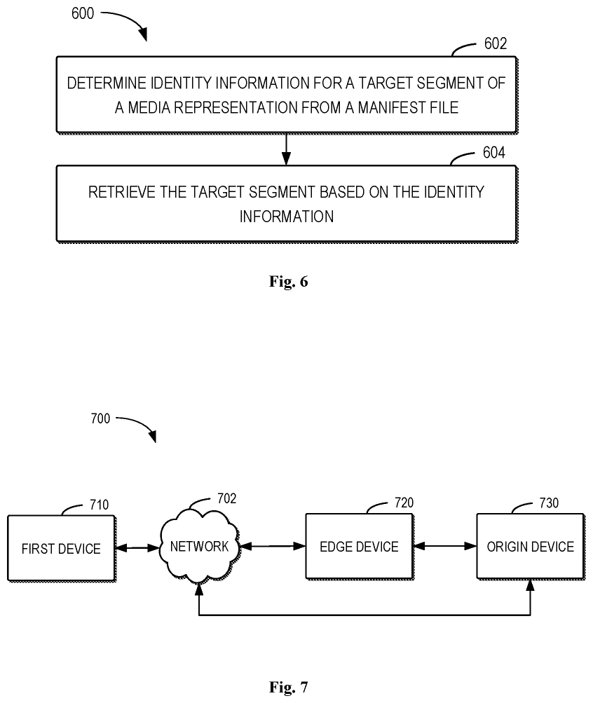

FIG. 6 illustrates a flowchart of a method 600 in accordance with some embodiments of the present disclosure. The method 600 may be implemented at a first device. For example, the method 600 may be implemented at a client or a media data receiver. The term “client” used herein may refer to a piece of computer hardware or software that accesses a service made available by a server as part of the client-server model of computer networks. Only as an example, the client may be a mobile device, such as smartphone or a tablet. In some embodiments, the first device may be implemented at the destination device 120 shown in FIG. 1.

At block 602, the first device determines identity information for a target segment of a media representation from a manifest file. Here, the target segment is a segment of the media representation that is expected to be retrieved by the first device. At block 604, the first device retrieves the target segment based on the identity information.

The manifest file may comprise representations corresponding to different coding characteristics (e.g., different profiles or levels of a video coding standard, different bitrates, different spatial resolutions, etc.). The manifest of such representations may be defined in a Media Presentation Description (MPD) data structure. In some embodiments, the manifest file may be a media presentation description (MPD) for content selection purposes, e.g., for selection of appropriate media segments both for initialization at the beginning of a streaming session and for stream adaptation during the streaming session. The MPD may be based on DASH.

In embodiments of the present disclosure, a new type of segment is proposed for a media representation, and the first device can retrieve this type of segment as a target segment. The proposed type of target segment can be specified in the manifest file, when applicable. In embodiments of the present disclosure, the proposed type of segment may sometimes be referred to as a Tuning-In Media Segment (TIMS).

Specifically, the proposed type of target segment is specified as comprising either a concatenation of an initialization segment (IS) and a media segment (if the initialization segment is absent from the manifest file) or just the media segment (if the initialization segment is absent from in the manifest file). The initialization segment may contain initialization information for accessing the representation. In general, the initialization segment does not contain media data. The media segment contains media data.

The target segment proposed in the present disclosure is uniquely referenced by corresponding identity information (or called an identifier). In some embodiments, the identity information may comprise a uniform resource locator (URL), uniform resource name (URN), uniform resource identifier (URI), or any other suitable identifiers. The manifest file (e.g., the MPD) may provide the identity information for the target segment. In some examples, the manifest file may also provide byte ranges in the form of a range attribute, which may correspond to the data for the target segment within a file accessible by the URL, URN, or URI.

With the identity information extracted from the manifest file, the first device can directly retrieve the corresponding target segment.

According to the embodiments of the present disclosure, by specifying a new type of segment, when the manifest file is perfected, the first device (e.g., a client) may be able to tune in and start to consume the media data by retrieving directly the target segment proposed herein. There is no need to request an MPD update each time before requesting a next media segment. With such a design of media data retrieving, the initialization delay could be reduced. This is suitable for a streaming media service, especially for a living streaming service where a client is required to request the latest MPD whenever tuning into a live streaming session, even if the client prefetched an earlier version of the MPD.

In some embodiments, in the proposed type of target segment, the media segment may comprise a media segment with the first access unit of the first movie fragment in each track corresponding to a random access point. In some embodiment, the media segment in the target segment may comprise a media segment with the first access unit of the first movie fragment in each track corresponding to an I_{SAU} of a Stream Access Point (SAP) of type 1, 2, or 3. The ISOBMFF specification specifies some types of SAPs for use with DASH. The first two SAP types (types 1 and 2) correspond to IDR pictures in H.264/AVC and HEVC. The third SAP type (type 3) corresponds to open-closed group of pictures (GOP) random access points hence broken link access (BLA) or clean random access (CRA) pictures in HEVC.

In some embodiments, the target segment proposed in the present disclosure may include a single media segment, although in other cases more than one media segment may be included. In some embodiments, the media segment comprised in the proposed type of target segment may be a Simple Media Segment. In some embodiments, alternatively, or in addition, the media segment comprised in the proposed type of target segment may be another type of media segment, for example, a Delivery Unit Media Segment, an Indexed Media Segment, a Random Access Media Segment, or any other type of media segment that is define to contain media data.

In some embodiments, the proposed type of target segment contains the latest media data for the first device to start with when a streaming media service is activated. In some embodiments, the first device may determine whether the streaming media service associated with the media representation is activated. If the streaming media service is activated, the first device may determine to retrieve the target segment and thus may first determine identity information for the target segment. In some embodiments, the streaming media service may comprise a live streaming service, such as a live broadcasting service. In this way, the first device may retrieve and display the latest media data with minimum initialization delay when tuning in the streaming media service.

In some cases, it may be difficult to ensure constant Segment durations for some streaming services. For example, the case of live streaming serving, the video camera may capture video at different varying frame rates. The video encoder may skip a frame from time to time due to computing resource issues. Therefore, it is not always possible to use the simple and nice approach based on the @duration attribute that specifies the constant approximate Segment duration. Consequently, many live streaming services use the SegmentTimeline element which specifies the timeline of arbitrary Segment durations

In some embodiments, if the ongoing media streaming service uses the SegmentTimeline element, for example, the manifest file includes the SegmentTimeline element instead of the @duration attribute, the proposed type of target segment may be specified in the manifest file, to minimize the initialization delay as discussed above.

In some embodiments, when MPD@type is “dynamic”, the target segment may contain the latest media data for clients to start with when tuning into the ongoing streaming service. In some embodiments, depending on the length of the current media segment that is being generated, the media segment in the proposed target segment may be either a current media segment (e.g., when the current media segment is made available with at least a couple of seconds of media data encapsulated) or a previous media segment (e.g., when only a small part of the current media segment has been generated).

In some embodiments, the target segment proposed herein may be specified in the manifest file as having a media segment type. As such, the target segment proposed herein may also conform to general definitions for media segments.

In some embodiments, the identity information for the target segment (i.e., Tuning-In Media Segment or TIMS) may be specified in a SegmentBase element in the manifest file. The SegmentBase element is to describe segment information, and identity information for the segment.

Table 1 below shows an example of semantics of the SegmentBase element for the target segment (with a name called “TuningIn”) and Segment Base Information type. It should be noted that Table 4 is only an example not limitation.

TABLE 1
Semantics of SegmentBase element and Segment Base Information type

| Element or Attribute Name | Use | Description |
|---|---|---|
| SegmentBase | | specifies Segment base element. |
| Segment Base Information | | This element also specifies the type for |
| | | the Segment base information that is |
| | | the base type for other elements. |
| . . . | . . . | . . . |
| TuningIn | 0 . . . 1 | specifies the URL including a possible |
| | | byte range for the Tuning-In Media |
| | | Segment. Alternatively, this specifies |
| | | the URL for the Tuning-In Media |
| | | Segment. |
| | | For the type definition, refer to below |
| | | Table 2. |

Key
For attributes:
M = mandatory,
O = optional,
OD = optional with default value,
CM = conditionally mandatory
For elements: < minOccurs> . . . < maxOccurs> (N = unbounded)
Elements are bold;
attributes are non-bold and preceded with an @.

TABLE 2
Semantics of elements of type URLType

| Element or Attribute Name | Use | Description |
|---|---|---|
| Element of type URLType | | defines an HTTP-URL |
| @sourceURL | O | specifies the source URL part and shall be |
| | | formatted either as an <absolute-URI> |
| | | according to IETF RFC 3986:2005, subclause |
| | | 4.3, with a fixed scheme of “http” or “https” or |
| | | as a <relative-ref> according to |
| | | IETF RFC 3986:2005, subclause 4.2. |
| | | If not present, then any BaseURL element is |
| | | mapped to the @sourceURL attribute and the |
| | | range attribute shall be present. |
| @range | O | specifies the byte range restricting the above |
| | | HTTP-URL. |
| | | The byte range shall be expressed and |
| | | formatted as a byte-range-spec as defined in |
| | | IETF RFC 7233:2014, subclause 2.1. It is |
| | | restricted to a single expression identifying a |
| | | contiguous range of bytes. |
| | | If not present, the element refers to the entire |
| | | resource referenced in the @sourceURL |
| | | attribute. |

In some embodiments, the identity information for the target segment is specified by an attribute in a SegmentTemplate element in the manifest file. The SegmentTemplate element is used to define a segment template to create the target segment (i.e., Tuning-In Media Segment or TIMS).

Table 3 below shows an example of semantics of the SegmentTemplate element for the target segment (with a name called “@tuningIn”) and Segment Base Information type. It should be noted that Table 4 is only an example not limitation.

TABLE 3
Semantics of SegmentTemplate element

| Element or Attribute Name | Use | Description |
|---|---|---|
| SegmentTemplate | | specifies Segment template information. |
| MultipleSegmentBaseInformation | | Provides the Multiple Segment base |
| | | information as defined in subclause |
| | | 5.3.9.2. |
| . . . | | . . . |
| @tuningIn | 0 | specifies the template to create the |
| | | Tunning-In Media Segment. Neither |
| | | $Number$ nor the $Time$ identifier shall |
| | | be included. |
| | | For more details, refer to subclause |
| | | 5.3.9.4.4. |

In some embodiments, a representation of media data may be assigned at most one target segment of the proposed type herein (i.e., the Tuning-In Media Segment). Alternatively, a representation may be assigned at zero or more Tuning-In Media Segments.

In some embodiments, the presence of a Tuning-In Media Segment is indicated by the presence of SegmentBase.TuningIn, SegmentList.TuningIn, the SegmentTemplate.TuningIn element or the SegmentTemplate@tuningIn that may contain URL and byte range information or URL construction rules for the Tuning-In Media Segment.

In some embodiments, when a Tuning-In Media Segment is present for a representation, the SegmentTemplate@media attribute with the $Number$ identifer (to indicate the number of the media segment) is used, and the SegmentTimeline element is used.

In some embodiments, a Live Streaming Tuning-In Event may be defined, for signalling of the segment number and/or the earliest presentation time of the target segment using the ‘emsg’ box. The first device may receive an event message for the target segment, e.g., the Live Streaming Tuning-In Event message. This message may indicate a segment number of the media segment in the target segment, and/or the earliest presentation time of the target segment.

In some embodiments, the live streaming tuning-in event may indicate that the current Segment is a Tuning-In Media Segment. This event may be identified by the URN “urn:mpeg:dash:event:tuin:2021”. In some embodiments, for events using this schema, the ‘emsg’.message_data[ ] field contains the DASHTuningIn structure defined below:

```
aligned(8) struct DASHTuningIn
{
  unsigned int(32) segment_number;
  unsigned int(64) earliest_presentation_time;
}
```

where segment_number provides the Segment number of the Media Segment part of the Tuning-In Media Segment; earliest_presentation_time provides the earlier presentation time of any access unit in the Tuning-In Media Segment. The timescale is provided in the timescale field of the current ‘emsg’ box.

In some embodiments, alternatively, the field earliest_presentation_time is not included in the DASHTuningIn structure.

In some embodiments, if the target segment is specified in the manifest file and its identity information is determined, the first device may retrieve the target segment with the identity information in various ways, depending on the specific application. In some embodiments, the first device may retrieve the target segment from a storage medium/server which has the target segment and possibly other segments cached. In some embodiments, the first device may retrieve the target segment directly from an origin device which prepare the streaming media data.

In some embodiments related to HTTP streaming according to DASH, the first device may retrieve the target segment by transmitting a request comprising the identity information for the target segment to a second device, which may be an edge device in a content delivery network (CDN) or an origin device of the media data. In response to the request, the second device may transmit the requested target segment (including a concatenation of the initialization segment and the media segment or just the media segment) to the first device. The first device may then receive the target segment, for example, for display.

For purpose of discussion, FIG. 7 illustrates a schematic diagram of an example system 700 that implements techniques for streaming media data over a network in accordance with some embodiments of the present disclosure. In this example, the system 700 includes a first device 710, an edge device 720 which may be in a CDN, and an origin device 730. The edge device 720 and the origin device 730 may be server devices.

In some examples, the first device 710 and the edge device 720 may be communicatively coupled by the network 702, which may comprise the Internet. In some examples, the edge device 720 and the origin device 730 may also be coupled by the network 702 or another network, or may be directly communicatively coupled. In some examples, the edge device 720 and the origin device 730 may comprise the same device. The origin device 730 prepares a representation(s) of media data and its manifest file. The first device 710 may retrieve media data prepared by the origin device 730 via the edge device 720 or directly from the origin device 730.

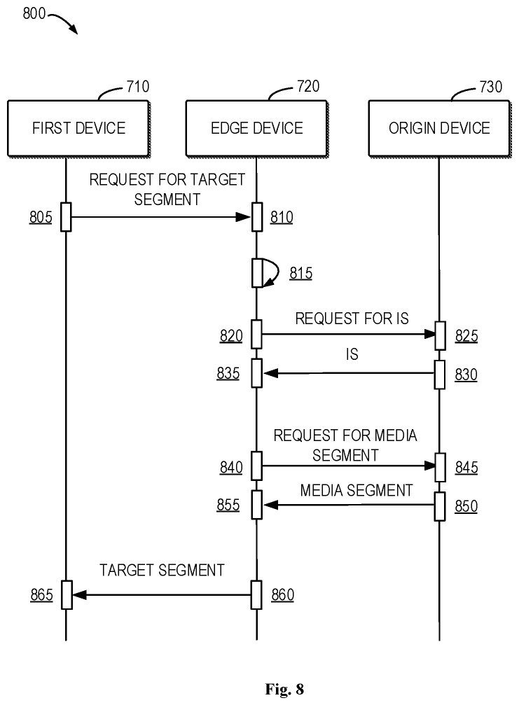

FIG. 8 illustrates a signaling flow 800 for streaming media data according to embodiments of the present disclosure. The signaling flow 800 involves the first device 710, the edge device 720, and the origin device 730. In this example, it is assumed that the first device 710 retrieves media data via the edge device 720 from the origin device 730. In some cases, if the edge device 720 and the origin device 730 are the same device, it is considered that the first device 710 retrieves media data from a server device.

In operation, the first device 710 determines identity information for a target segment from a manifest file, for example, when the first device 710 turns in a live streaming service. The first device 710 transmits (805), to the edge device 720, a request for the target segment. The identity information (e.g., URL) for the target segment is included in the request. In some examples, the request may be a HTTP request, for example, a GET request.

Upon receiving (810) the request from the first device 710, the edge device 720 will provide the requested target segment to the first device 710. As mentioned above, the target segment (Tuning-In Media Segment) may comprise either a concatenation of an initialization segment and a media segment or just a media segment, the edge device 720 determines (815) whether the initialization segment and/or the media segment is stored in a cache. If any requested segment is cached, the edge device 720 may load the segment from its cache.

In the illustrated example in FIG. 8, it is assumed that none of the initialization segment and the media segment requested by the target segment is cached, the edge device 720 may request the origin device 730 for the two segments.

In some embodiments, the edge device 720 may request the initialization segment and the media segment via separate requests (e.g., HTTP requests) if the target segment comprises a concatenation of the initialization segment and the media segment. Specifically, the edge device 720 transmits (820) a request for the initialization segment to the origin device 730, and transmits (840) a request for the media segment comprised in the requested target segment to the origin device 730. Upon receiving (825, 845) the two requests, the origin device 730 transmits (830, 850) the requested initialization segment and media segment to the edge device 720, for example, in HTTP responses.

In some embodiments (not illustrated in FIG. 8), if either one of the initialization segment and the media segment are cached, the edge device 720 may request the other one of non-cached segment from the origin device 730.

In some embodiments, if the edge device 720 is not be able to determine which media segment is to be included into the target segment, the origin device 730 may notify the edge device 720 which media segment is to be included in the target segment in some ways, including but not limited to carrying identity information (e.g., URL) of the media segment within a header of a HTTP response. In some embodiments, if the edge device 720 has no information about the media segment to be included in the target segment, then the edge device 720 may request the origin device 730 for the whole target segment, for example, by providing the identity information for the target segment in a normal HTTP request.

Upon receiving (835, 855) the initialization segment and the media segment from the origin device 730 and/or loading one or both of them from the cache, the edge device 720 transmits 860 the target segment comprising the initialization segment and the media segment. In other cases, the target segment may comprise just the media segment (e.g., if the initialization segment is included in the manifest file prefetched by the first device 710). The first device 710 receives (865) the target segment.

In some embodiments, the edge device 720 may generate a Multipurpose Internet Mail Extensions (MIME) message by placing the initialization segment and the media segment in different parts of the MIME message and transmit the MIME message to the first device 710. In some embodiments, the initialization segment may be placed and followed by the media segment. An example of the structure of the MIME message is shown in FIG. 4.

In some embodiments, if the target segment is specified to include just the media segment in some cases, the target segment may also be provided by the MIME message. In other embodiments, the target segment may be provided in any other suitable message.

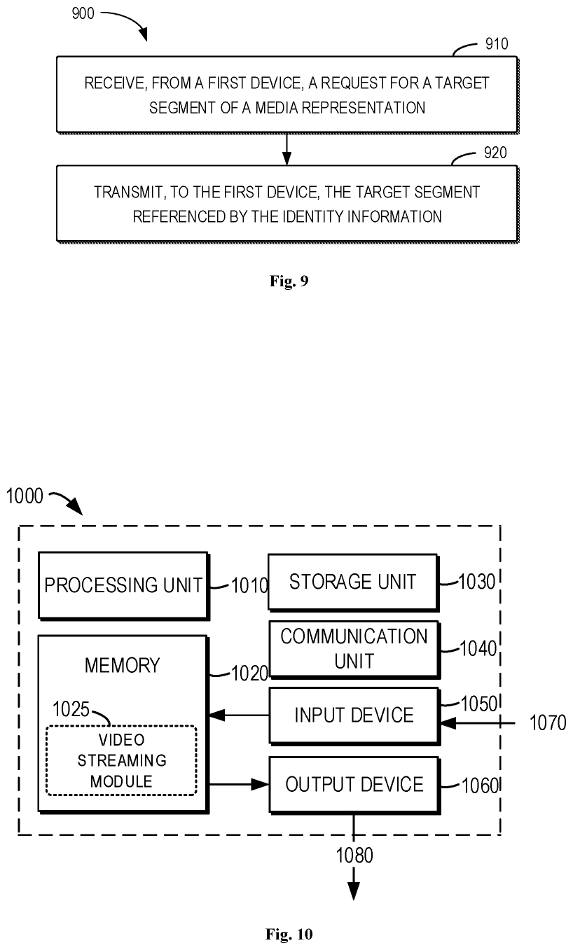

FIG. 9 illustrates a flowchart of a method 900 for providing media data in accordance with some embodiments of the present disclosure. The method 900 may be implemented at a second device. For example, the method 900 may be implemented at a server or a media data sender. The term “server” used herein may refer to a device capable of computing, in which case the client accesses the service by way of a network. The server may be a physical computing device or a virtual computing device. In some embodiments, the second device may be implemented at the source device 110 shown in FIG. 1 or the edge device 720 or the origin device 730 shown in FIG. 7.

At block 910, the second device receives, from a first device, a request for a target segment of a media representation. The request comprises identity information for the target segment, and the target segment comprises one of the following: a concatenation of an initialization segment for the media representation and a media segment containing media data if the initialization segment is absent from the manifest file, or the media segment containing the media data if the initialization segment is present in the manifest file.

At block 920, the second device transmits, to the first device, the target segment referenced by the identity information.

In some embodiments, the second device may comprise an origin server of the media representation or an edge server of a content delivery network (CDN).

In some embodiments, if the target segment comprises the initialization segment and the media segment, the second device may generate a Multipurpose Internet Mail Extensions (MIME) message by placing the initialization segment and the media segment in different parts of the MIME message. The second device may transmit the MIME message to the first device.

In some embodiments, to generate the MIME message, the second device may determine whether at least one of the initialization segment and the media segment is stored in a cache. If at least one of the initialization segment and the media segment is stored in the cache, the second device may generate the MIME message by loading the at least one segment from the cache. If at least one of the initialization segment and the media segment is missed from the cache, the second device may transmit a request for the at least one segment to an origin server of the media representation. The second device may receive the at least one segment from the origin server, and generate the MIME message based on the at least one received segment.

In some embodiments, the second device (e.g., an edge device in the CDN) may receive, from an origin server of the media representation, identity information for the media segment in the target segment. The second device may determine the media segment to be included in the target segment based on the received identity information for the media segment.

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.

Clause 1. A method for retrieving media data, comprising: determining, by a first device, identity information for a target segment of a media representation from a manifest file, the target segment being specified as comprising one of the following: a concatenation of an initialization segment for the media representation and a media segment containing media data if the initialization segment is absent from the manifest file, or the media segment containing the media data if the initialization segment is present in the manifest file; and retrieving the target segment based on the identity information.

Clause 2. The method of clause 1, wherein the media segment comprises a media segment with a first access unit of a first movie fragment in each track corresponding to a random access point.

Clause 3. The method of clause 2, wherein the media segment in the target segment comprises a media segment with a first access unit of a first movie fragment in each track corresponding to an ISAU of a stream access point (SAP) of type 1, 2, or 3.

Clause 4. The method of any of clauses 1-3, wherein the media segment in the target segment comprises one of the following: a Simple Media Segment, a Delivery Unit Media Segment, an Indexed Media Segment, or a Random Access Media Segment.

Clause 5. The method of clause 1, wherein retrieving the target segment comprises: in accordance with a determination that a streaming media service associated with the media representation being activated, retrieving the target segment.

Clause 6. The method of clause 5, wherein the target segment contains latest media data for the first device to start with when the streaming media service is activated.

Clause 7. The method of any of clauses 1-6, wherein the media segment in the target segment comprises: an available current media segment or a previous media segment.

Clause 8. The method of any of clauses 1-7, wherein retrieving the target segment comprises: transmitting, by the first device to a second device, a request comprising the identity information for the target segment; and receiving, from the second device, the target segment.

Clause 9. The method of clause 8, wherein receiving the target segment comprising: if the target segment comprises the initialization segment and the media segment, receiving the target segment in a Multipurpose Internet Mail Extensions (MIME) message, the initialization segment and the media segment being placed in different parts of the MIME message.

Clause 10. The method of clause 8, wherein transmitting the request comprises: transmitting the request to an edge device of a content delivery network (CDN).

Clause 11. The method of any of clauses 1-10, wherein the identity information for the target segment comprises a uniform resource locator (URL) for the target segment.

Clause 12. The method of any of clauses 1-11, wherein the identity information for the target segment is specified in a SegmentBase element in the manifest file.

Clause 13. The method of any of clauses 1-12, wherein the identity information for the target segment is specified by an attribute in a SegmentTemplate element in the manifest file.

Clause 14. The method of any of clauses 1-13, further comprising: receiving an event message for the target segment, the event message indicating at least one of the following: a segment number of the media segment in the target segment, or an earliest presentation time of the target segment.

Clause 15. The method of any of clauses 1-14, wherein the manifest file comprises a SegmentTimeline element.

Clause 16. The method of any of clauses 1-15, wherein the target segment is specified as of a media segment type in the manifest file.

Clause 17. The method of any of clauses 1-16, wherein the manifest file comprises a multimedia presentation description (MPD) file.

Clause 18. A method of providing media data, comprising: receiving, by a second device from a first device, a request for a target segment of a media representation, the request comprising identity information for the target segment, and the target segment comprising one of the following: a concatenation of an initialization segment for the media representation and a media segment containing media data if the initialization segment is absent from the manifest file, or the media segment containing the media data if the initialization segment is present in the manifest file; and transmitting, to the first device, the target segment referenced by the identity information.

Clause 19. The method of clause 18, wherein the second device comprises an origin device of the media representation or an edge device of a content delivery network (CDN).

Clause 20. The method of clause 18, wherein transmitting the target segment comprising: if the target segment comprises the initialization segment and the media segment, generating a Multipurpose Internet Mail Extensions (MIME) message by placing the initialization segment and the media segment in different parts of the MIME message; and transmitting the MIME message to the first device.

Clause 21. The method of clause 19, wherein generating the MIME message comprises: determining whether at least one of the initialization segment and the media segment is stored in a cache; if at least one of the initialization segment and the media segment is stored in the cache, generating the MIME message by loading the at least one segment from the cache; and if at least one of the initialization segment and the media segment is missed from the cache, transmitting a request for the at least one segment to an origin device of the media representation, receiving the at least one segment from the origin device, and generating the MIME message based on the at least one received segment.

Clause 22. The method of clause 19, further comprising: receiving, from an origin device of the media representation, identity information for the media segment in the target segment, and wherein the media segment in the target segment is determined based on the received identity information for the media segment.

Clause 23. An apparatus for receiving media data comprising a processor and a non-transitory memory with instructions thereon, wherein the instructions upon execution by the processor, cause the processor to perform a method in accordance with any of clauses 1-17.

Clause 24. An apparatus for providing media data comprising a processor and a non-transitory memory with instructions thereon, wherein the instructions upon execution by the processor, cause the processor to perform a method in accordance with any of clauses 18-22.

Clause 25. A non-transitory computer-readable storage medium storing instructions that cause a processor to perform a method in accordance with any of clauses 1-17.

Clause 26. A non-transitory computer-readable storage medium storing instructions that cause a processor to perform a method in accordance with any of clauses 18-22.

### Example Device

FIG. 10 illustrates a block diagram of a computing device 1000 in which various embodiments of the present disclosure can be implemented. The computing device 1000 may be implemented as or included in the source device 110 (or the video encoder 114 or 200) or the destination device 120 (or the video decoder 124 or 300).

It would be appreciated that the computing device 1000 shown in FIG. 10 is merely for purpose of illustration, without suggesting any limitation to the functions and scopes of the embodiments of the present disclosure in any manner.

As shown in FIG. 10, the computing device 1000 includes a general-purpose computing device 1000. The computing device 1000 may at least comprise one or more processors or processing units 1010, a memory 1020, a storage unit 1030, one or more communication units 1040, one or more input devices 1050, and one or more output devices 1060.

In some embodiments, the computing device 1000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1000 can support any type of interface to a user (such as “wearable” circuitry and the like).

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk or another other media, which can be used for storing information and/or data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem and the like) enabling the computing device 1000 to communicate with one or more other computing devices, if required. Such communication can be performed via input/output (I/O) interfaces (not shown).

In some embodiments, instead of being integrated in a single device, some or all components of the computing device 1000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1000 may be used to implement video encoding/decoding in embodiments of the present disclosure. The memory 1020 may include one or more video streaming modules 1025 having one or more program instructions. These modules are accessible and executable by the processing unit 1010 to perform the functionalities of the various embodiments described herein.

In the example embodiments of performing video encoding, the input device 1050 may receive video data as an input 1070 to be encoded. The video data may be processed, for example, by the video streaming module 1025, to generate an encoded bitstream. The encoded bitstream may be provided via the output device 1060 as an output 1080.

In the example embodiments of performing video decoding, the input device 1050 may receive an encoded bitstream as the input 1070. The encoded bitstream may be processed, for example, by the video streaming module 1025, to generate decoded video data. The decoded video data may be provided via the output device 1060 as the output 1080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for retrieving media data, comprising:
determining, by a first device, identity information for a target segment of a media representation from a manifest file, the target segment being specified as comprising one of the following:
a concatenation of an initialization segment for the media representation and a media segment containing media data if the initialization segment is absent from the manifest file, or
the media segment containing the media data if the initialization segment is present in the manifest file; and
retrieving the target segment based on the identity information.

2. The method of claim 1, wherein the media segment comprises a media segment with a first access unit of a first movie fragment in each track corresponding to a random access point; and
wherein the media segment in the target segment comprises a media segment with a first access unit of a first movie fragment in each track corresponding to an I_{SAU} of a stream access point (SAP) of type 1, 2, or 3, and/or
wherein the media segment in the target segment comprises one of the following: a Simple Media Segment, a Delivery Unit Media Segment, an Indexed Media Segment, or a Random Access Media Segment.

3. The method of claim 1, wherein retrieving the target segment comprises:
in accordance with a determination that a streaming media service associated with the media representation being activated, retrieving the target segment,
wherein the target segment contains latest media data for the first device to start with when the streaming media service is activated.

4. The method of claim 1, wherein the media segment in the target segment comprises: an available current media segment or a previous media segment; and
wherein retrieving the target segment comprises:
transmitting, by the first device to a second device, a request comprising the identity information for the target segment; and
receiving, from the second device, the target segment.

5. The method of claim 4, wherein receiving the target segment comprising:
if the target segment comprises the initialization segment and the media segment, receiving the target segment in a Multipurpose Internet Mail Extensions (MIME) message, the initialization segment and the media segment being placed in different parts of the MIME message, and
wherein transmitting the request comprises:
transmitting the request to an edge device of a content delivery network (CDN).

6. The method of claim 1, wherein the identity information for the target segment comprises a uniform resource locator (URL) for the target segment; and/or
wherein the identity information for the target segment is specified in a SegmentBase element in the manifest file; and/or
wherein the identity information for the target segment is specified by an attribute in a SegmentTemplate element in the manifest file.

7. The method of claim 1, further comprising:
receiving an event message for the target segment, the event message indicating at least one of the following:
a segment number of the media segment in the target segment, or
an earliest presentation time of the target segment.

8. The method of claim 1, wherein the manifest file comprises a SegmentTimeline element; and/or
wherein the target segment is specified as of a media segment type in the manifest file; and/or
wherein the manifest file comprises a multimedia presentation description (MPD) file.

9. A method of providing media data, comprising:
receiving, by a second device from a first device, a request for a target segment of a media representation, the request comprising identity information for the target segment, and the target segment comprising one of the following:
a concatenation of an initialization segment for the media representation and a media segment containing media data if the initialization segment is absent from the manifest file, or
the media segment containing the media data if the initialization segment is present in the manifest file; and
transmitting, to the first device, the target segment referenced by the identity information.

10. The method of claim 9, wherein the second device comprises an origin device of the media representation or an edge device of a content delivery network (CDN).

11. The method of claim 9, wherein transmitting the target segment comprising:
if the target segment comprises the initialization segment and the media segment, generating a Multipurpose Internet Mail Extensions (MIME) message by placing the initialization segment and the media segment in different parts of the MIME message; and
transmitting the MIME message to the first device.

12. The method of claim 11, wherein generating the MIME message comprises:
determining whether at least one of the initialization segment and the media segment is stored in a cache;
if at least one of the initialization segment and the media segment is stored in the cache, generating the MIME message by loading the at least one segment from the cache; and
if at least one of the initialization segment and the media segment is missed from the cache,
transmitting a request for the at least one segment to an origin device of the media representation,
receiving the at least one segment from the origin device, and
generating the MIME message based on the at least one received segment.

13. The method of claim 11, further comprising:
receiving, from an origin device of the media representation, identity information for the media segment in the target segment, and
wherein the media segment in the target segment is determined based on the received identity information for the media segment.

14. An apparatus for receiving media data comprising a processor and a non-transitory memory with instructions thereon, wherein the instructions upon execution by the processor, cause the processor to perform acts comprising:
determining, by a first device, identity information for a target segment of a media representation from a manifest file, the target segment being specified as comprising one of the following:
a concatenation of an initialization segment for the media representation and a media segment containing media data if the initialization segment is absent from the manifest file, or
the media segment containing the media data if the initialization segment is present in the manifest file; and
retrieving the target segment based on the identity information.

15. The apparatus of claim 14, wherein the media segment comprises a media segment with a first access unit of a first movie fragment in each track corresponding to a random access point; and
wherein the media segment in the target segment comprises a media segment with a first access unit of a first movie fragment in each track corresponding to an I_{SAU} of a stream access point (SAP) of type 1, 2, or 3, and/or
wherein the media segment in the target segment comprises one of the following: a Simple Media Segment, a Delivery Unit Media Segment, an Indexed Media Segment, or a Random Access Media Segment.

16. The apparatus of claim 14, wherein retrieving the target segment comprises:
in accordance with a determination that a streaming media service associated with the media representation being activated, retrieving the target segment,
wherein the target segment contains latest media data for the first device to start with when the streaming media service is activated.

17. The apparatus of claim 14, wherein the media segment in the target segment comprises: an available current media segment or a previous media segment; and
wherein retrieving the target segment comprises:
transmitting, by the first device to a second device, a request comprising the identity information for the target segment; and
receiving, from the second device, the target segment.

18. The apparatus of claim 17, wherein receiving the target segment comprising:
if the target segment comprises the initialization segment and the media segment, receiving the target segment in a Multipurpose Internet Mail Extensions (MIME) message, the initialization segment and the media segment being placed in different parts of the MIME message, and
wherein transmitting the request comprises:
transmitting the request to an edge device of a content delivery network (CDN).

19. The apparatus of claim 14, wherein the identity information for the target segment comprises a uniform resource locator (URL) for the target segment; and/or
wherein the identity information for the target segment is specified in a SegmentBase element in the manifest file; and/or
wherein the identity information for the target segment is specified by an attribute in a SegmentTemplate element in the manifest file.

20. The apparatus of claim 14, further comprising:
receiving an event message for the target segment, the event message indicating at least one of the following:
a segment number of the media segment in the target segment, or
an earliest presentation time of the target segment.
